(19) United States
(12) Patent Application Publication
(10) Pub. No.: US 2008/0162697 A1
(43) Pub. Date: Jul. 3, 2008

(54) Power-Based Resource Sharing in a Mesh Network

(75) Inventors: Jeffrey Jason Griffin, Raleigh, NC (US); Gary Cole, Cary, NC (US)

Correspondence Address: COATS & BENNETT/SONY ERICSSON, 1400 CRESCENT GREEN, SUITE 300, CARY, NC, 27511, US

(73) Assignee: Sony Ericsson Mobile Communications AB, Lund (SE)

(21) Appl. No.: 11/617,136

(22) Filed: Dec. 28, 2006

(51) Int. Cl. G06F 15/16

(52) U.S. Cl. 709/226

(57) ABSTRACT

A method of sharing processing loads among a plurality of communication devices interconnected within a mesh network is described herein. According to one exemplary embodiment, a communication device with a processing load selects one or more helpers to share the processing load from a set of load sharing candidates within the mesh network. To select the helpers, the communication device assesses the available power resources for each of the candidates, and selects one or more helpers based on power availability criterion. The requesting device then allocates a portion of the processing load to each selected helper.

### BACKGROUND

The present invention relates generally to mesh networks, and more particularly to sharing processing resources between multiple communication devices in mesh networks.

Mesh networks interconnect wireless and/or wired communication devices to form a co-operative communication infrastructure. Each device in the mesh network operates as a node for routing communication signals. As a result, communication signals originating from one device hop from node to node within the mesh network to arrive at the target device.

Because mesh networks interconnect a large number of communication devices, mesh networks provide an ideal opportunity for sharing processing resources. For example, a device having available processing resources may execute a processing task for another device in the mesh network having limited processing resources. This enables the task to be completed, and in some cases enables the task to be completed more efficiently.

Originally, mesh networks contained only wired communication devices. As such, each device was connected to an essentially unlimited power supply. However, modern mesh networks may also include wireless devices with limited power resources. Thus, while a particular device may have sufficient processing resources, it may not have the power resources required to complete a task.

### SUMMARY

The present invention relates to a method of sharing processing loads among a plurality of communication devices interconnected within a mesh network. According to one exemplary embodiment, a communication device with a processing load selects one or more helpers to share the processing load from a set of candidates that are available for load sharing. To select the helpers, the requesting communication device assesses the available power resources for each of the candidates and selects one or more helpers based on power availability criterion. The requesting device then allocates a portion of the processing load to each selected helper.

### BRIEF DESCRIPTION OF THE DRAWINGS

FIG. 1 shows an exemplary mesh network containing a plurality of wired and wireless communication devices.

FIG. 2 shows a block diagram of one exemplary communication device.

FIG. 3 shows one exemplary resource sharing process according to the present invention.

FIG. 4 shows a signal flow diagram for determining power availability according to one exemplary embodiment.

FIG. 5 shows a signal flow diagram for determining power availability according to another exemplary embodiment.

### DETAILED DESCRIPTION

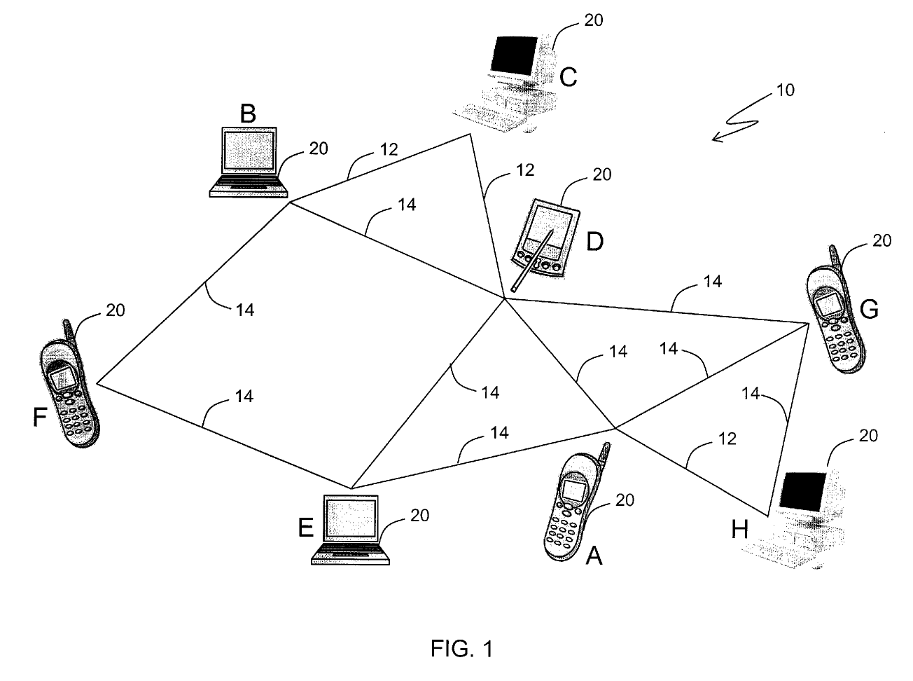

FIG. 1 shows one exemplary mesh network 10 comprising a plurality of communication devices 20 interconnected by wired communication links 12 or wireless communication links 14. Exemplary communication devices 20 include, but are not limited to, cellular telephones, personal computers, laptop computers, network computers, palmtop computers, and personal data assistants (PDA). Each device 20 serves as a network node capable of routing analog and/or digital data within the mesh network 10. Further, each device 20 provides processing resources that may be shared with other communication devices 20 in the mesh network 10 to complete various processing tasks, such as data compression, image processing, audio processing, etc. For example, mobile phone A may forward an image to laptop computer B with a request that the laptop computer B compress the image. While distributed processing is known, most load sharing schemes evolved in the context of fixed networks where the devices sharing the load had essentially unlimited power resources. In the exemplary communication network 10 shown in FIG. 1, many of the communication devices 20 may have only limited power resources. While such communication devices 20 may have processing capacity to share, the shared processing load may represent an undesirable drain on its limited power resources

The present invention solves this problem by considering the available power resources of the communication devices 20 in the mesh network 10 when deciding how a processing load should be divided and shared. More particularly, a communication device 20 looking to share a processing task, referred to herein as a requesting device, identifies a set of candidates available to share the processing load. The set of load sharing candidates generally includes those communication devices 20 in the mesh network 10 that have sufficient power and processing capacity to share. The requesting device determines the available power resources for each candidate. Based on the available power resources of the candidates, the requesting device selects one or more helpers from the set of candidates and allocates a portion of the processing task to each selected helper. The entire processing task may be completed by one helper or may be divided and distributed among a plurality of helpers.

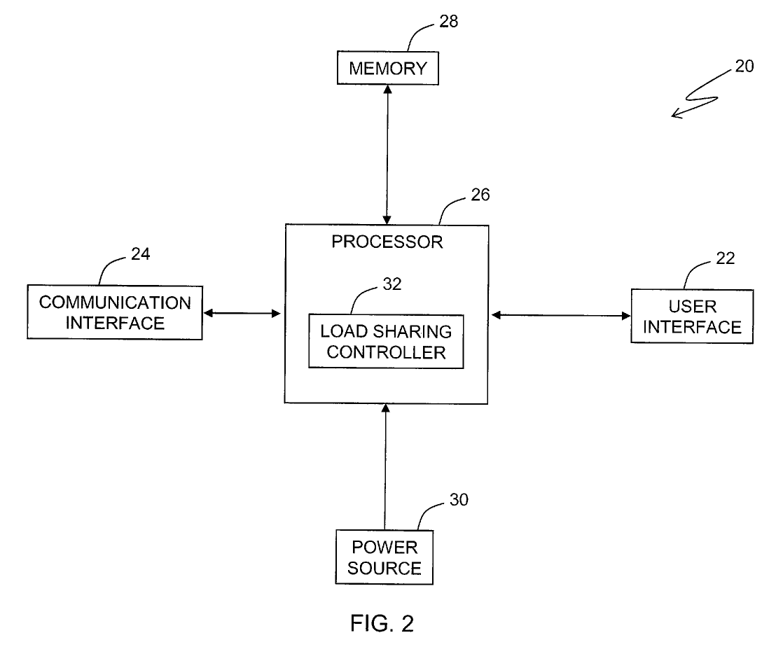

FIG. 2 shows a block diagram of an exemplary communication device 20 according to the present invention. Communication device 20 includes a user interface 22, communication interface 24, processor 26, memory 28, and power source 30. The user interface 22 provides a means for the user to interface with the communication device 20. While not explicitly shown, user interface 22 may include a keypad and/or other user input devices, a display, a speaker, a microphone, etc. Communication interface 24 transmits and receives data to and from remote communication devices 20 in the mesh network 10. The communication interface 24 may comprise any known wired communication interface, such as a serial port or parallel port. Alternatively or in addition, communication interface 24 may comprise any known wireless interface that transmits and receives wireless signals according to any known standard, including the standards known generally as the Bluetooth, Global System for Mobile Communications (GSM), TIA/EIA-136, cdmaOne, cdma2000, UMTS, and Wideband CDMA. Processor 26 controls the operation of the communication device 20 according to programs stored in memory 28. Power source 30 provides power to the electronic components in communication device 20. Power source 30 may comprise a battery. Alternatively or in addition, power source 30 may comprise an interface to an external power supply, such as an AC power supply.

When a communication device 20 determines it does not have sufficient power resources and/or processing resources to complete a task, the communication device 20 searches the mesh network 10 for one or more helpers to assist with the processing task. To that end, a communication device 20 of the present invention may include a load sharing controller 32. Load sharing controller 32 identifies the candidates, available to share the processing load, evaluates the available power resources of each candidate, and selects one or more helpers from the available candidates to share the processing load. The load sharing controller 32 then divides and allocates respective portions of the processing task to the selected helpers. While FIG. 2 shows the load sharing controller 32 as part of processor 26, it will be appreciated that the load sharing controller 32 may be a separate device from processor 26. Further, it will be appreciated that processor 26 may alternatively perform the operations of load sharing controller 32.

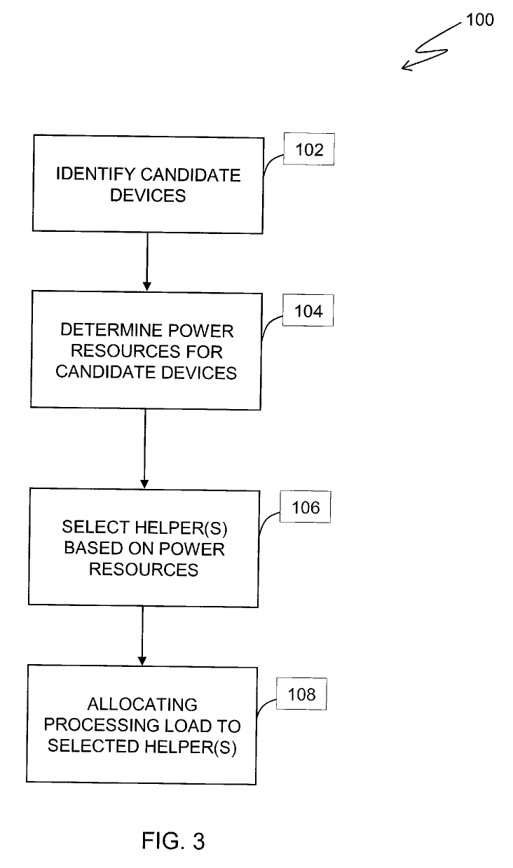

FIG. 3 shows a flow chart for a load sharing method 100 according to one exemplary embodiment of the present invention. When a requesting device identifies a task that either can be or should be shared, load sharing controller 32 identifies one or more candidates in the mesh network 10 (block 102). Load sharing controller 32 then determines the available power resources for each candidate (block 104), and selects one or more helpers from among the available candidates based on the available power resources (block 106). The requesting device then allocates a portion of the processing task to each selected helper (block 108).

The following example illustrates how the processing load is shared in one exemplary embodiment. It will be appreciated that this example is for illustrative purposes and therefore is not limiting. Mobile phone A in FIG. 1 wants to compress an image. Mobile phone A may be unable to perform the compression task because it does not have a compression application and/or because it does not have sufficient processing capacity or power to perform the compression. According to one embodiment, the mobile phone A identifies a set of candidates in the mesh network 10 with available processing and power resources to share, and determines the available power resources for each candidate. For this example, assume the set of candidates comprises laptop B, personal computer C, PDA D, and laptop E, where devices B, D, and E have limited battery power resources, and device C has essentially unlimited power resources. Because personal computer C has unlimited power resources, mobile phone A selects personal computer C for the image compression task. Mobile phone A forwards the image to personal computer C with a request to compress the image via laptop B. After personal computer C compresses the image, the personal computer C either returns the compressed image to mobile phone A or forwards the compressed image to one or more designated recipients.

The candidates for load sharing may comprise all communication devices 20 in the communication network 10, or a subset of the communication devices 20. In the later case, the candidates may be pre-defined or pre-selected. In one exemplary embodiment, the communication devices 20 individually determine their available processing capacity and power resources and declare themselves available as candidates for load sharing

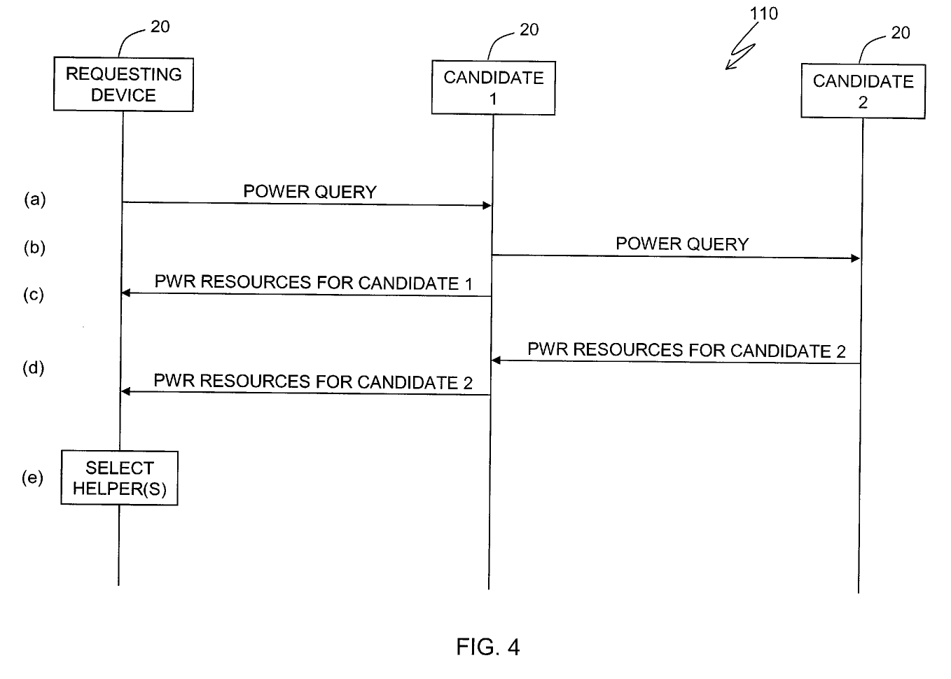

FIG. 4 illustrates an exemplary process for determining the available power resources for a set of load sharing candidates. As shown in FIG. 4, when a requesting device needs to perform a processing task, the requesting device sends a power resource query to each candidate in the network 10 (steps a and b). In response to the query, each candidate sends information regarding its available power resources to the requesting device (steps c and d). Based on the received power resource information, the requesting device selects one or more of the candidates as the helper(s) (step e).

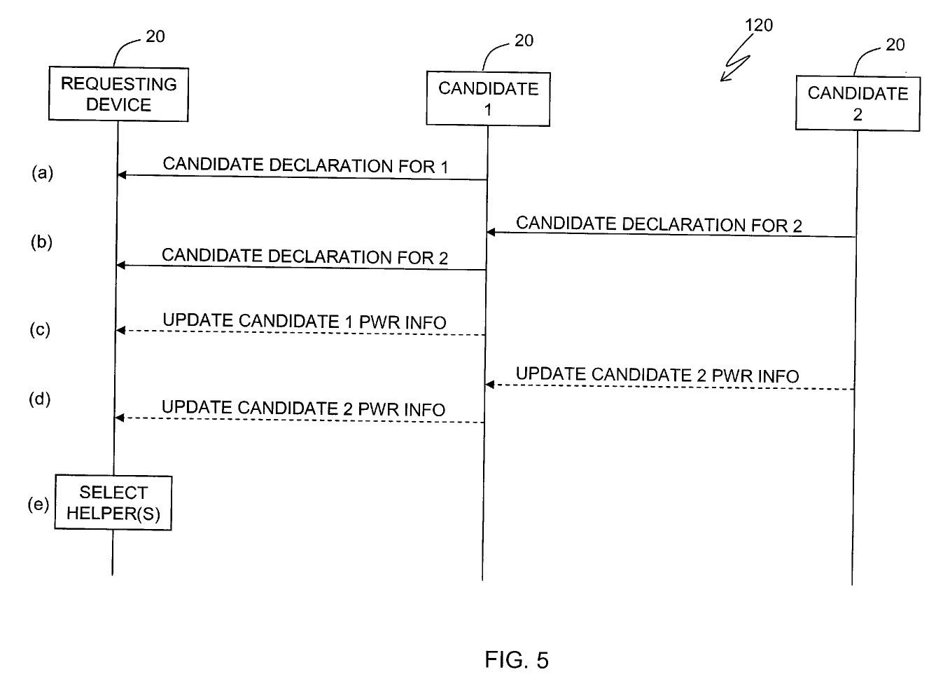

FIG. 5 illustrates another exemplary method for determining the available power of candidates. In the embodiment of FIG. 5, each communication device 20 in the mesh network 10 determines its available processing capacity and power resources. Based on these factors, the communications devices 20 decide whether to make processing resources available to its peers. If so, the communication devices 20 announce their availability as a load sharing candidate by sending an announcement message to the other communication devices 20 (steps a and b). The announcement message may include information regarding the available power resources of the announcing communication device 20. After announcing their availability, each candidate periodically updates its power resource information (steps c and d). The communication devices 20 in the mesh network 10 store the received power resource information for each candidate in memory. When a communication device 20 determines that a processing task needs to be performed, the communication device selects one or more of the candidates for load sharing based on the power resource information stored in memory (step e).

Both the query and periodic update methods discussed above require the candidates to send power resource information to one or more communication devices 20 in the mesh network 10. The power resource information may be sent as data bytes in some portion of a data message. For example, candidates may send their power resource information by transmitting a specific power resource message formatted according to any known protocol. Exemplary message formats include SNMP (Simple Network Management Protocol), TCP/IP (Transmission Control Protocol/Internet Protocol), etc. Alternatively, the candidates may send their power resource information within an existing data packet. For this embodiment, a header or data field of the data packet may be extended to include the pertinent power resource information.

Generally, the power resource information provided by each candidate includes information regarding the type of power, i.e., battery or AC power, and the relative power state, i.e., the amount of remaining battery power. The power resource information may further include secondary information, i.e., the number of node hops between the requesting device and the helper. For example, data containing power resource information may comprise the data bytes shown in Table 1.

TABLE 1

| | |
|---|---|
| Number of Hops | Relative Power State |
| (one byte of data) | (two bytes of data) |

| | | | |
|---|---|---|---|
| 0 | Direct connection | 00–FE | 0–100% battery power in |
| | | | 0.4% steps |
| 1–F | 1 to 15 hops | FF | AC power |

Based on the received power resource information, a requesting device selects one or more of the candidates as helpers. In one embodiment, the requesting device selects the n available candidate with the most available power as the helper(s). For example, the requesting device may prefer candidates having a generally unlimited AC power source as helpers. Alternatively, the requesting device may select the candidate(s) having the most available battery power as the helper(s) if no candidates have an AC power source. It will be appreciated that the requesting device may opt to do all or part of the processing task itself (if possible) when no candidate has sufficient power to complete the task. Alternatively, requesting device defer the processing task until a candidate having sufficient power becomes available.

The requesting device may take one or more secondary factors into account when selecting a candidate for load sharing. Secondary factors include, but are not limited to, the number of node hops between the requesting device and the candidates, and the processing resources of the candidate, i.e., processing speed and/or processing capacity. Information regarding the secondary factors may be included with a power resource update and/or in response to a power resource query.

To illustrate the operation of the present invention in view of possible secondary factors, consider the following example with reference to FIG. 1. Assume the set of candidates comprises all of the communication devices 20 in the illustrated mesh network 10. Further, assume that mobile phone A wants an image compressed and forwarded to mobile phone G. Upon recognizing that personal computer C and personal computer H both have generally unlimited AC power sources, mobile phone A may initially select one or both of these candidates as the helper(s) to perform the image compression. Mobile phone A may also consider one or more secondary factors when selecting the helper. For example, if mobile phone A is concerned with minimizing the number of node hops, the mobile phone A may choose personal computer H as the helper. Alternatively, if mobile phone A is more concerned with processing resources, and if personal computer C has more processing resources than personal computer H, mobile phone A may select personal computer C as the helper.

It will further be appreciated that a requesting device may consider the available power resources of the intervening communication devices 20 serving as mesh network nodes that transport the task data to the selected helper(s). For example, if mobile phone A selects laptop B as the helper, mobile phone A may transmit the task data to laptop B via PDA D or via laptop E and phone F. If PDA D is low on power, mobile phone A may choose to send the task data to laptop B via laptop E and phone F, even though this path requires two node hops. This enables mobile phone A to increase the probability that the task data will safely arrive at the intended destination.

The above describes how communication devices 20 in a mesh network 10 share processing resources based on the available power resources of one or more candidates. In so doing, the communication device 20 of the present invention takes advantage of the available resources within the mesh network 10 while improving the probability that selected helpers are fully capable of handling the processing task.

The present invention may, of course, be carried out in other ways than those specifically set forth herein without departing from essential characteristics of the invention. The present embodiments are to be considered in all respects as illustrative and not restrictive, and all changes coming within the meaning and equivalency range of the appended claims are intended to be embraced therein.

What is claimed is:

1. A method for sharing processing resources between two or more communication devices connected within a mesh network, the method comprising:
determining available power resources for each load sharing candidate in a set of load sharing candidates in the mesh network; and
selecting one or more helpers from said set of load sharing candidates for sharing a processing load based on said available power resources of said candidates.

2. The method of claim 1 wherein the set of load sharing candidates comprises each of the communication devices in the mesh network.

3. The method of claim 1 further comprising:
receiving a candidate announcement from one or more of the communication devices in the mesh network; and
identifying each communication device associated with a received announcement as a load sharing candidate.

4. The method of claim 3 wherein the announcement includes power resource information for the corresponding candidate.

5. The method of claim 1 wherein the set of load sharing candidates comprises one or more pre-designated communication devices in the mesh network.

6. The method of claim 1 wherein determining the available power resources comprises:
sending a power query to each load sharing candidate; and
receiving power information from each load sharing candidate responsive to said power query.

7. The method of claim 1 wherein determining the available power resources comprises receiving periodic power updates from each load sharing candidate.

8. The method of claim 1 wherein selecting the one or more helpers comprises selecting the one or more helpers with the largest available power.

9. The method of clam 1 wherein selecting the one or more helpers further comprises selecting the one or more helpers based on a processing speed associated with each load sharing candidate.

10. The method of claim 1 wherein selecting the one or more helpers further comprises selecting the one or more helpers based on a processing capacity associated with each load sharing candidate.

11. The method of claim 1 wherein selecting the one or more helpers further comprises selecting the one or more helpers based on a number of intervening network nodes required to transport data from a requesting device to each load sharing candidate.

12. The method of claim 11 wherein selecting the one or more helpers based on the number of intervening network nodes comprises selecting the one or more helpers requiring the fewest number of intervening network nodes.

13. The method of claim 11 further comprising determining the available power resources associated with each network node, wherein selecting the one or more helpers based on the number of intervening network nodes comprises selecting the one or more helpers based on the intervening network nodes having the most available power resources.

14. The method of claim 1 further comprising allocating a portion of the processing load to each selected helper.

15. A communication device in a mesh network comprising a plurality of interconnected communication devices, the communication device comprising:
a communication interface configured to receive power resource information from each load sharing candidate in a set of load sharing candidates in the mesh network; and
a load sharing controller configured to select one or more helpers from said set of load sharing candidates based on the received power resource information.

16. The communication device of claim 15 wherein the set of load sharing candidates comprises each of the communication devices in the mesh network.

17. The communication device of claim 15 wherein the communication interface is further configured to receive a candidate announcement from one or more of the communication devices in the mesh network, and wherein the load sharing controller is further configured to identify each communication device associated with a received announcement as a load sharing candidate.

18. The communication device of claim 17 wherein the announcement includes power resource information for the corresponding candidate.

19. The communication device of claim 15 wherein the set of load sharing candidates comprises one or more pre-designated communication devices in the mesh network.

20. The communication device of claim 15 wherein the communication interface is further configured to:
send a power query to each load sharing candidate; and
receive power information from each load sharing candidate responsive to said power query.

21. The communication device of claim 15 wherein the communication interface is further configured to receive periodic power updates from each load sharing candidate.

22. The communication device of claim 15 wherein the load sharing controller is configured to select the one or more helpers with the largest available power.

23. The communication device of clam 15 wherein the load sharing controller is further configured to select the one or more helpers based on a processing speed associated with each load sharing candidate.

24. The communication device of claim 15 wherein the load sharing controller is further configured to select the one or more helpers based on a processing capacity associated with each load sharing candidate.

25. The communication device of claim 15 wherein the load sharing controller is further configured to select the one or more helpers based on a number of intervening network nodes required to transport data from the communication device to each load sharing candidate.

26. The communication device of claim 25 wherein the load sharing controller is configured to select the one or more helpers requiring the fewest number of intervening network nodes.

27. The communication device of claim 25 wherein the communication interface is further configured to determine the available power resources associated with each network node, and wherein the load sharing controller is further configured to select the one or more helpers based on the intervening network nodes having the most available power resources.

28. The communication device of claim 15 wherein the load sharing controller is further configured to allocate a portion of the processing load to each selected helper.

29. A method of sharing processing resources between communication devices in a mesh network comprising a plurality of communication devices, the method comprising sharing a processing load between a requesting device and one or more helpers interconnected in the mesh network based on available power resources associated with the one or more helpers.
